(19) United States
(12) Patent Application Publication
(10) Pub. No.: US 2005/0105446 A1
(43) Pub. Date: May 19, 2005

(54) Optical pickup apparatus

(75) Inventors: Katsuya Sakamoto, Tokyo (JP); Junji Hashimura, Tokyo (JP); Kiyono Ikenaka, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Opto, Inc., Tokyo (JP)

(21) Appl. No.: 10/987,853

(22) Filed: Nov. 12, 2004

(30) Foreign Application Priority Data
Nov. 14, 2003 (JP) 2003-385029
Dec. 25, 2003 (JP) 2003-429495
Oct. 22, 2004 (JP) 2004-307803

(51) Int. Cl. G11B 7/00

(52) U.S. Cl. 369/112.01; 369/44.37

(57) ABSTRACT

This invention provides an optical pickup apparatus which includes a plurality of light sources, a beam shaping element which is arranged in an optical path through which a light beam emitted from at least one of the light sources passes, and an optical system which includes a divergence angle conversion element and an objective lens and is arranged in an optical path through which the light beams emitted from the plurality of light sources pass, and records and/or reproduces information by condensing, through the objective lens, the light beam emitted from each light source on the information recording surface of a corresponding optical information recording medium. An almost elliptical cross-sectional shape of the light beam which enters the beam shaping element is shaped into a cross-sectional shape closer to an almost circular shape or a circular shape, and the light beam emerges from the beam shaping element. The light beam which enters the divergence angle conversion element emerges from it with a reduced angle or degree of divergence.

### FIELD OF THE INVENTION

The present invention relates to an optical pickup apparatus and, more particularly, to a compatible optical pickup apparatus which can record and/or reproduce information on/from at least two different optical information recording media by using light beams emitted from a plurality of light sources having different light source wavelengths.

### BACKGROUND OF THE INVENTION

In recent years, high-power DVD laser diodes have been developed so that a write on DVDs is possible.

As one method for high-speed recording on DVDs, the light amount is increased by using a high-power light source. More specifically, when the output of a semiconductor laser (laser diode) serving as a light source is raised, the light amount can be increased. However, this may lead to a high cost or an adverse influence on the apparatus due to an increase of heat generation.

As a method for increasing the light utilization efficiency without making the light source power up, a beam shaping element (beam shaping lens) is suitably used. When a cross-section of the light beam is so reshaped by making use of the beam shaping element as to become nearer circle, it makes possible to collect a residual part of the light beam which has not been collected heretofore, thereby improving remarkably the light utilization efficiency.

In addition, when a wavelength of the light beam is used, high-speed recording on DVDs can be executed while suppressing the output of the laser relatively low. Further, when the beam shaping element is integrated with a coupling element, the number of components can be reduced while maintaining a high light utilization efficiency. Hence, a compact apparatus and low cost can be implemented.

Recently, research and development of high-density optical disk systems are underway by rapid strides. A high-density optical disk system can record/reproduce information by making use of a blue-violet semiconductor laser having a wavelength of about 400 nm. For example, when an optical disk which executes information recording/reproduction under specifications including an NA of 0.65 and a light source wavelength of 407 nm (such an optical disk will be referred to as a “high-density DVD” hereinafter in this specification) is used, 20- to 30-GB information can be recorded on one surface of an optical disk which has a diameter of 12 cm, i.e., the same size as a DVD (NA: 0.6, light source wavelength: 650 nm, and storage capacity: 4.7 GB).

The capability of appropriately recording/reproducing information on/from such high-density DVDs cannot sufficiently increase the value of optical pickup apparatuses as products yet. Considering the fact that DVDs and CDs with a variety of information recorded are commercially available, the product value of the compatible optical pickup apparatuses can be increased by making it possible not only to appropriately record/reproduce information on/from high-density DVDs but also to appropriately record/reproduce information on/from, e.g., conventional DVDs or CDs held by users.

Under the circumstances, a condensing optical system used in a compatible optical pickup apparatus is required to have performance capable of appropriately recording/reproducing information on/from both high-density DVDs and conventional DVDs and CDs while maintaining the compatibility.

In the compatible optical pickup apparatus, generally, a light beam which should enter an objective lens is converted into a parallel beam by using a collimator lens, thereby improving the condensing characteristic of the objective lens. A blue-violet semiconductor laser having a light source wavelength of about 407 nm, currently under development, has an elliptical crass-section in a direction perpendicular to the optical axis. Since it is inappropriate to use this light directly as recording light, the beam is shaped by using a beam shaping element such as a beam shaping lens (refer to Japanese Unexamined Patent Publication No. 2002-323673).

Accordingly, when a red semiconductor laser for recording/reproducing on/from the DVD and an infrared semiconductor laser for recording/reproducing on/from a CD are used as light sources in the compatible optical pickup apparatus, the above-mentioned high-speed recording problem is generally caused in the recording on the DVD. As a result, as regards a light beam emitted from the infrared semiconductor laser, there is a circumstance such that it is not always necessary to conduct the beam shaping at the same reshaping ratio.

On the other hand, in case of a dual compatible formation in which the blue-violet semiconductor laser for recording/reproducing on/from the high-density DVD and the red semiconductor laser for recording/reproducing on/from the DVD are used as the light sources or in case of a ternary compatible formation in which the infrared semiconductor laser for recording/reproducing on/from the CD is further used as another light source in addition to the above two lasers, the spotlight of public attention is focused on a problem of high-cost due to the provision of recording/reproduction on/from the high-density DVD which is the supreme grade. As a result, as regards a light beam emitted from the red semiconductor laser for recording/reproducing on/from the DVD, there is a circumstance such that it is not always necessary to conduct the beam shaping at the same reshaping ratio.

There is no prior art of the layout of a collimator lens and a beam shaping lens so far as the present inventors know. To implement a compact arrangement, a careful consideration must be given to the layout.

### SUMMARY OF THE INVENTION

The present invention has been made in consideration of the above-described problems of the prior art, and has as its first object to provide an optical pickup apparatus which increases the light utilization efficiency.

It is the second object of the present invention to provide a compatible optical pickup apparatus which can appropriately record/reproduce information on/from different kinds of optical information recording media.

In order to achieve the above objects, according to the first main aspect of the present invention, there is provided an optical pickup apparatus, comprising: a first light source emitting a first light beam having a wavelength λ1; a second light source emitting a second light beam having a wavelength λ2 (λ1<λ2); and an optical system including a beam shaping element which is arranged in an optical path through which only the first light beam passes, a divergence angle conversion element which is arranged in an optical path through which the first and the second light beams pass, and an objective lens, in which the apparatus being configured to make it possible to record and/or reproduce information by condensing, through the objective lens, the first light beam on a first optical information recording medium covered with a protective layer having a thickness t1, and make it possible to record and/or reproduce information by condensing the second light beam on a second optical information recording medium covered with a protective layer having a thickness t2 (t1≦t2), wherein the beam shaping element is so made as to output the first light beam having a nearer circle cross-section, while the first light beam just after emitted from the first light source having an elliptical cross-section, which is defined by tracing points with an intensity 50% of a peak intensity of the first light beam and effects an inequality α>1 in which α is a ratio of a length “x” of the major axis of the elliptical cross-section to a length “y” of the minor axis thereof, and wherein the divergence angle conversion element is so made as to output the first light beam and the second light beam whose respective divergence angles are reduced.

In the arrangement according to the first aspect, when the beam splitter is inserted between the beam shaping element and the divergence angle conversion element, only the light beam emitted from the first light source (e.g., a blue-violet semiconductor laser) can be made to enter the beam shaping element and reshaped. Then, the light beam is caused to pass through the divergence angle conversion element to change the angle of divergence. On the other hand, the light beam from the second light source (e.g., a red semiconductor laser) can be made to enter the divergence angle conversion element to change the angle of divergence without passing through the beam shaping element. That is, the apparatus includes the single divergence angle conversion element, and only the light beam emitted from the first light source can be reshaped by the beam shaping element. Hence, a compact optical pickup apparatus capable of appropriately recording and/or reproducing information in accordance with the type of an optical information recording medium can be provided.

According to the second main aspect of the present invention, there is provided an optical pickup apparatus, comprising: a first light source emitting a first light beam having a wavelength λ1; a second light source emitting a second light beam having a wavelength λ2 (λ1<λ2); and an optical system including a beam shaping element which is arranged in an optical path through which only the first light beam passes, a divergence angle conversion element which is arranged in an optical path through which the first and the second light beams pass, and an objective lens, in which the apparatus being configured to make it possible to record and/or reproduce information by condensing, through the objective lens, the first light beam on a first optical information recording medium covered with a protective layer having a thickness t1, and make it possible to record and/or reproduce information by condensing the second light beam on a second optical information recording medium covered with a protective layer having a thickness t2 (t1≦t2), wherein the beam shaping element is so made as to output the first light beam having an approximately circle cross-section, while the first light beam just after emitted from the first light source having an elliptical cross-section, which is defined by tracing points with an intensity 50% of a peak intensity of the first light beam and effects an inequality α>1 in which α is a ratio of a length “x” of the major axis of the elliptical cross-section to a length “y” of the minor axis thereof, and wherein the divergence angle conversion element is so made as to output the first light beam and the second light beam whose respective divergence angles are reduced.

By the arrangement according to the second aspect, a compact optical pickup apparatus capable of appropriately recording and/or reproducing information in accordance with the type of an optical information recording medium can be also provided as same as the first aspect.

According to the third main aspect of the present invention, there is provided an optical pickup apparatus, comprising: a first light source emitting a first light beam having a wavelength λ1; a second light source emitting a second light beam having a wavelength λ2 (λ1<λ2); a third light source emitting a third light beam having a wavelength λ3 (λ2<λ3); and an optical system including a first beam shaping element which is arranged in an optical path through which only the first light beam passes, a second beam shaping element which is arranged in an optical path through which only the second light beam passes, a divergence angle conversion element which is arranged in a common optical path through which the first and the second light beams pass, and an objective lens, in which the apparatus being configured to make it possible to record and/or reproduce information by condensing, through the objective lens, the first light beam on a first optical information recording medium covered with a protective layer having a thickness t1, and in which make it possible to record and/or reproduce information by condensing the second light beam on a second optical information recording medium covered with a protective layer having a thickness t2 (t1≦t2), and in which make it possible to record and/or reproduce information by condensing the third light beam on a third optical information recording medium covered with a protective layer having a thickness t3 (t2<t3), wherein the beam shaping element is so made as to output the first light beam having a nearer circle cross-section, while the first light beam just after emitted from the first light source having an elliptical cross-section, which is defined by tracing points with an intensity 50% of a peak intensity of the first light beam and effects an inequality α>1 in which a is a ratio of a length “x” of the major axis of the elliptical cross-section to a length “y” of the minor axis thereof, and wherein the divergence angle conversion element is so made as to output the first light beam and the second light beam whose respective divergence angles are reduced.

By the arrangement according to the third aspect, a compact and excellent cost benefit optical pickup apparatus capable of appropriately recording and/or reproducing information on/from different three kinds of optical information recording media including a high-density DVD can be provided.

As is apparent from the above-described aspects, according to the present invention, an optical pickup apparatus which can execute high-speed recording on a DVD by increasing the light utilization efficiency without increasing the power of the light source can be provided.

According to the present invention, a compact and excellent cost benefit optical pickup apparatus which can appropriately record and/or reproduce information on/from different kinds of optical information recording media can be provided.

Several technical terms used in this specification will be defined below.

First of all, an “approximately circle cross-section” includes at least a cross-section such that, in case of making the cross-section approximate to an ellipse, such a ration as (the major axis−the minor axis)/the major axis is not more than 10%, preferably not more than 5%.

“Astigmatism” indicates an astigmatism component of wave aberration at a spot condensed on the information recording surface of an optical information recording medium.

“Spherical aberration” indicates a spherical aberration component of wave aberration at a spot condensed on the information recording surface of an optical information recording medium.

A “divergence angle conversion element” is an optical element having a function of reducing the angle of divergence of a divergent light beam from a semiconductor laser light source and includes a divergence angle conversion element as a simple substance, a collimator lens, and an optical element which generally includes a lens consisting of combination of these lens. These optical elements may include a plurality of lenses.

A “first optical information recording medium” indicates an optical disk based on high-density DVDs such as an HD-DVD and BD (Blue-ray Disc). A “second optical information recording medium” indicates an optical disk based on various kinds of DVDs such as a DVD-ROM or DVD-Video dedicated to reproduce and a DVD-RAM, DVD-R, and DVD-RW used for both reproduction and recording. A third optical information recording medium indicates an optical disk based on CDs such as a CD-R and CD-RW.

### BRIEF DESCRIPTION OF THE DRAWINGS

FIG. 1 is a view schematically showing the overall arrangement of an optical pickup apparatus according to the first embodiment of the present invention;

FIG. 2 is a view for explaining the function of a beam shaping element (beam shaping lens);

FIG. 3 is a graph in which spherical aberration (SA3) and astigmatism (AS3) which occur when a light beam from a first light source is condensed in the optical system according to the first embodiment shown in FIG. 1 are plotted along the ordinate, and a temperature change is plotted along the abscissa;

FIG. 4 is a graph in which spherical aberration (SA3) which occurs when a light beam from a second light source is condensed in the optical system according to the first embodiment shown in FIG. 1 is plotted along the ordinate, and a temperature change is plotted along the abscissa;

FIG. 5 is a graph showing a collimator (CL) shift distance characteristic;

FIG. 6 is a view schematically showing the overall arrangement of an optical pickup apparatus according to the second embodiment of the present invention;

FIG. 7 is a view schematically showing the overall arrangement of an optical pickup apparatus according to the third embodiment of the present invention; and

FIG. 8 is a view schematically showing the overall arrangement of an optical pickup apparatus according to the fourth embodiment of the present invention.

### DETAILED DESCRIPTION OF THE PREFERRED EMBODIMENTS

Several preferred embodiment of the present invention will be described below in detail with reference to the accompanying drawings.

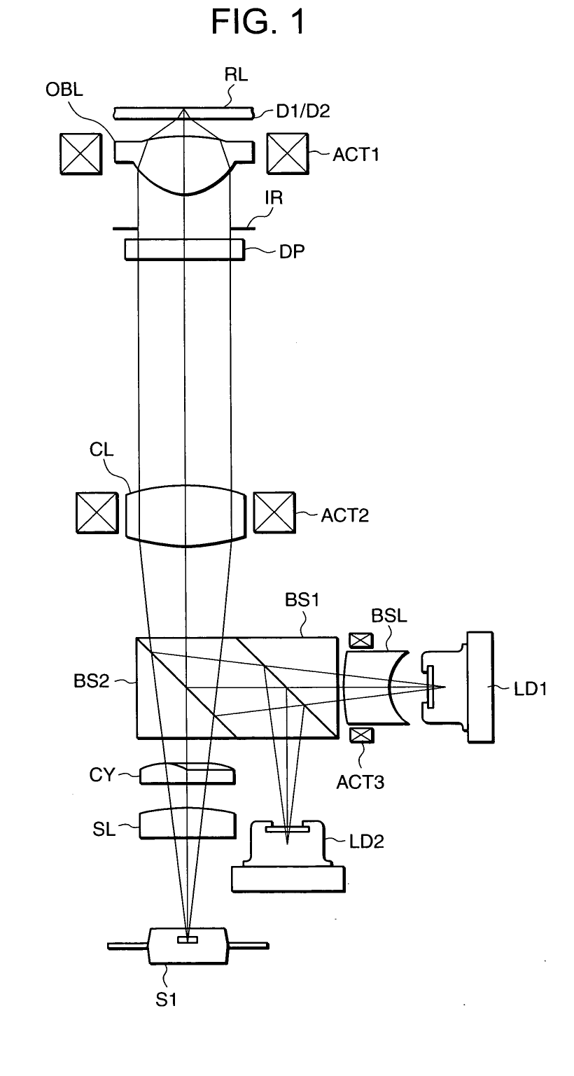

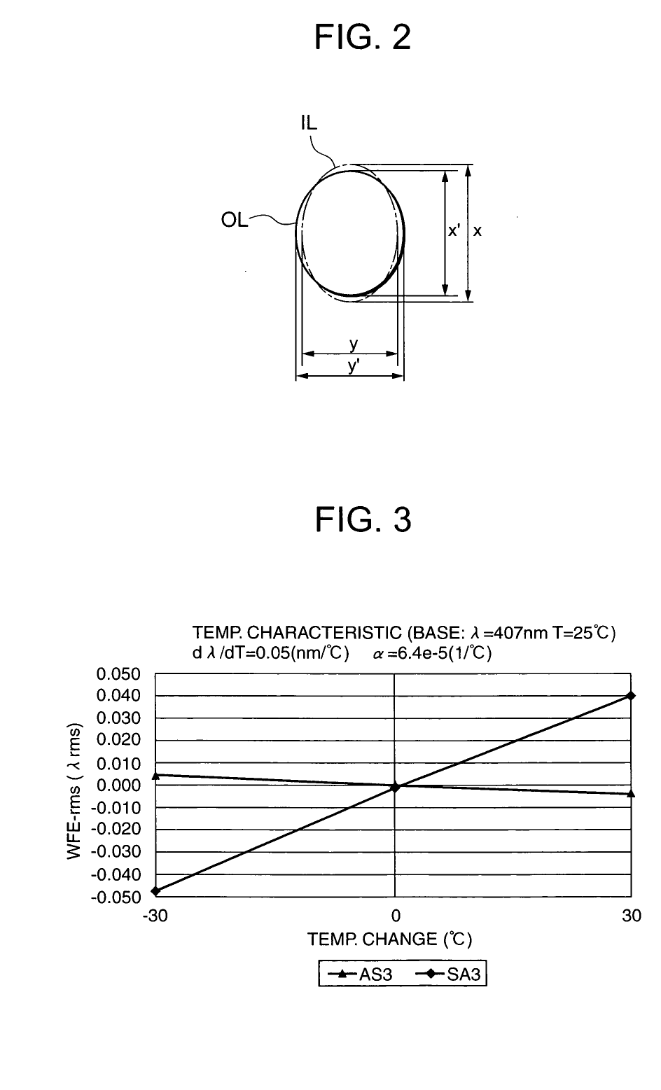

FIG. 1 is a view schematically showing the overall arrangement of an optical pickup apparatus according to the first embodiment of the present invention. This optical pickup apparatus can record/reproduce information on/from both a high-density DVD (to be also referred to as a first optical disk D1) and a conventional DVD (to be also referred to as a second optical disk D2). FIG. 2 is a view showing a crass-section of a light beam which enters a beam shaping lens BSL serving as a beam shaping element and a crass-section of a light beam which exits from the beam shaping lens in a direction perpendicular to the optical axis.

Referring to FIG. 1, a divergent light beam emitted from a first semiconductor laser LD1 (wavelength λ1=380 to 430 nm; 407 nm in this embodiment) serving as a first light source enters the beam shaping lens BSL first. As shown in FIG. 2, a light beam IL which has entered the beam shaping lens BSL has an almost elliptical cross-section formed by tracing points with an intensity 50% of the peak intensity of the light beam. More specifically, let “x” be the longest distance in the first direction (vertical direction) of the cross-sectional shape, and “y” be the distance in the second direction (horizontal direction) perpendicular to the first direction. A ratio α of the distance “x” in the first direction to the distance “y” in the second direction of the incident light beam IL is given by α=x/y. Since x>y, α>1 holds inevitably.

Although not illustrated, in the beam shaping lens BSL, the radius of curvature in the first direction is smaller than that in the second direction. Hence, when the light beam passes through the beam shaping lens BSL, its cross-sectional shape in the direction perpendicular to the optical axis changes. More specifically, let “x′” be the distance in the first direction (vertical direction) of the cross-sectional shape of an emerging light beam OL, and “y′” be the distance in the second direction (horizontal direction). A ratio α′ of the distance “x′” in the first direction to the distance “y′” in the second direction of the emerging light beam OL is given by α′=x′/y′. Since x′>y′, α′>1. In addition, since x/x′>y/y′, α>α′. Hence, α>α′>1 holds. In this case, α is called an “aspect ratio”, and α>α′ is called a “beam shaping magnification”.

According to the present invention, the incident light beam can emerge from the beam shaping lens BSL while having an almost circular or perfectly circular cross-sectional shape in the direction perpendicular to the optical axis such that α>α′ holds. For this reason, a spot having excellent characteristics can be condensed on the information recording surface of an optical disk by using the light beam from the first light source. In this case, the light beam may have a perfectly circular cross-section. To do this, however, the optical surface of the beam shaping lens BSL must have a high accuracy of form, and this may undesirably increase the cost. If the beam shaping lens BSL has an optical surface form to ensure the relationship α>α′>1, the radius of curvature in the first direction can be made closer to that in the second direction, unlike the beam shaping lens BSL which has an optical surface form necessary for obtaining a perfectly circular light beam cross-section. For this reason, any astigmatism caused by a positional shift can be suppressed.

Here, it should be noted that α′ is within a range of more than 1.2, preferably more than 1.5, and not less than 2.7, preferably not less than 2.5.

Referring to FIG. 1, the cross-sectional shape of the light beam emitted from the first semiconductor laser LD is corrected upon passing through the beam shaping lens BSL. Then, the light beam passes through a first beam splitter BS1 and is reflected by a second beam splitter BS2 and converted into a parallel beam by a collimator lens CL. The light beam further passes through a λ/4-plate DP and is restricted through an aperture stop IR and condensed on an information recording surface RL through the protective layer (thickness t1=0.05 to 0.7 mm and, preferably, 0.1 or 0.6 mm) of the first optical disk D1 through an objective lens OBL.

The light beam from the first semiconductor laser LD1, which is modulated and reflected by an information pit of the information recording surface RL, sequentially passes through the objective lens OBL, aperture stop IR, and λ/4-plate DP again and is given a convergent angle by the collimator lens CL. The light beam passes through the second beam splitter BS2, is given astigmatism by a cylindrical lens CY, and strikes a photodetector S1 through a sensor lens SL. A read signal of information recorded on the first optical disk D1 can be obtained by using the signal output from the photodetector S1.

A change in light amount caused by a change in shape or position of the spot on the photodetector S1 is detected to execute focusing or tracking. More specifically, on the basis of detection of the light amount change, a two-dimensional actuator ACT1 displaces the objective lens OBL such that the image of the light beam from the first semiconductor laser LD1 is formed on the recording surface of the first optical disk D1 (focusing), and the image of the light beam from the first semiconductor laser LD1 is formed on a predetermined track (tracking).

On the other hand, a light beam emitted from a second semiconductor laser LD2 (wavelength λ2=600 to 700 nm; 660 nm in this embodiment) serving as a second light source is reflected by the first beam splitter BS1 and second beam splitter BS2 and converted into a parallel beam by the collimator lens CL. The light beam further passes through the λ/4-plate DP and is restricted through the aperture stop IR and condensed on the information recording surface RL of the second optical disk D2 through the protective layer (thickness t2=0.5 to 0.7 mm and, preferably, 0.6 mm) of the second optical disk D2 through the objective lens OBL.

The light beam from the second semiconductor laser LD2, which is modulated and reflected by an information pit of the information recording surface RL, sequentially passes through the objective lens OBL, aperture stop IR, and λ/4-plate DP again and is given a convergent angle by the collimator lens CL. The light beam passes through the second beam splitter BS2, is given astigmatism by the cylindrical lens CY, and strikes the photodetector S1 through the sensor lens SL. A read signal of information recorded on the second optical disk D2 can be obtained by using the signal output from the photodetector S1.

A change in light amount caused by a change in shape or position of the spot on the photodetector S1 is detected to execute focusing or tracking. More specifically, on the basis of detection of the light amount change, the two-dimensional actuator ACT1 displaces the objective lens OBL such that the image of the light beam from the second semiconductor laser LD2 is formed on the recording surface of the second optical disk D2 (focusing), and the image of the light beam from the second semiconductor laser LD2 is formed on a predetermined track (tracking).

According to the present invention, the first beam splitter BS1 is inserted between the beam shaping lens BSL and the collimator lens CL serving as a divergence angle conversion element (coupling lens). Accordingly, only the light beam emitted from the first semiconductor laser LD1 as a blue-violet semiconductor laser can be input to the beam shaping lens BSL and shaped. After that, the angle of divergence is changed by causing the light beam to pass through the collimator lens CL. On the other hand, the light beam emitted from the second semiconductor laser LD2 as a red semiconductor laser is reflected by the first beam splitter BS1 and enters the collimator lens CL to change the angle of divergence without passing through the beam shaping lens BSL. That is, the apparatus includes the single collimator lens CL, and only the light beam emitted from the first semiconductor laser LD1 can be shaped by the beam shaping lens BSL. Hence, a light utilization efficiency is raised, and a compact optical pickup apparatus capable of appropriately recording and/or reproducing information on/from the information recording surfaces RL of the different kinds of optical disks D1 and D2 can be provided.

When high-speed recording on a DVD should be executed by using the light beam emitted from the second semiconductor laser LD2, the effective efficiency of light can be increased by shaping the beam by using the beam shaping lens, like the light beam emitted from the first semiconductor laser LD1.

The beam shaping lens BSL, collimator lens CL and objective lens OBL included in the optical system are made of plastic. Hence, the refractive indices change in accordance with a temperature change. Accordingly, spherical aberration degradation occurs in the entire optical system.

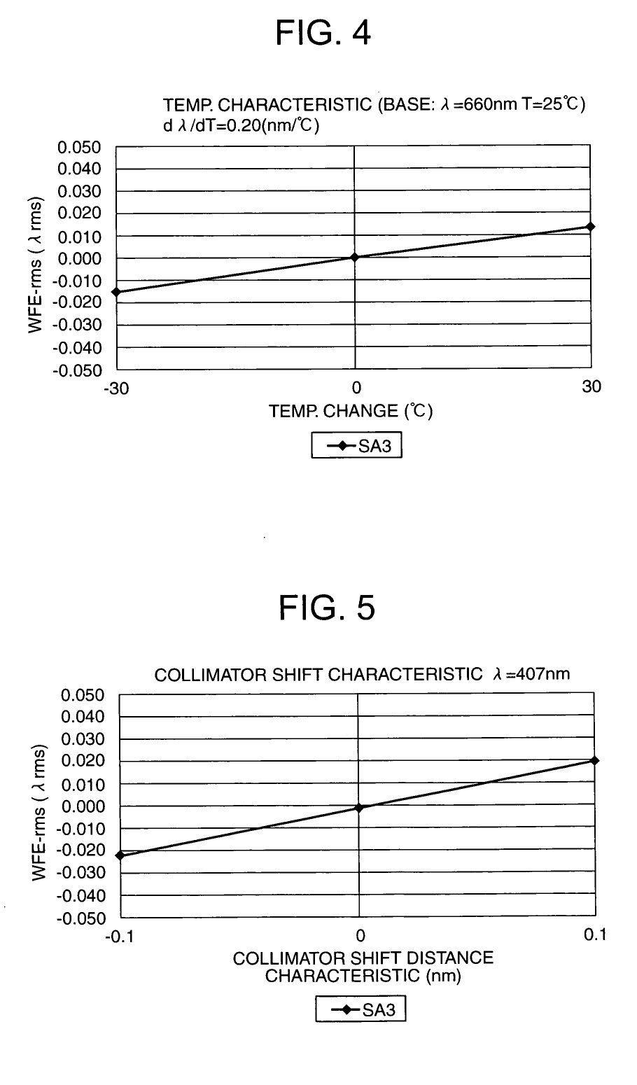

FIG. 3 is a graph in which spherical aberration (SA3) and astigmatism (AS3) which occur when the light beam from the first light source is condensed in the optical system of the optical pickup apparatus according to the first embodiment of the present invention are plotted along the ordinate, and a temperature change is plotted along the abscissa. FIG. 4 is a graph in which spherical aberration (SA3) which occurs when the light beam from the second light source is condensed in the optical system of the optical pickup apparatus according to the first embodiment of the present invention is plotted along the ordinate, and a temperature change is plotted along the abscissa.

Referring to FIG. 3, the spherical aberration is 0 at the base temperature (25° C.). When the temperature changes by −30° C., spherical aberration of −0.048 λrms occurs. When the temperature changes by +30° C., spherical aberration of +0.040 λrms occurs. Referring to FIG. 4, the spherical aberration is 0 at the base temperature (25° C.). When the temperature changes by −30° C., spherical aberration of −0.016 λrms occurs. When the temperature changes by +30° C., spherical aberration of +0.013 λrms occurs. Note that α in FIGS. 3 and 4 indicates an average coefficient of linear expansion.

In the present invention, spherical aberration is corrected by the method to be described below.

Referring to FIG. 1, the collimator lens CL is supported such that it can be displaced in the axial direction by an actuator ACT2. The collimator lens CL exhibits a characteristic shown in FIG. 5 upon receiving a light beam having a light source wavelength of 407 nm. More specifically, when the collimator lens CL is displaced from the reference position by −0.1 mm in the direction of optical axis (displaced to the light source side by 0.1 mm), spherical aberration of −0.02 λrms occurs, as shown in FIG. 5. Conversely, when the collimator lens CL is displaced by +0.1 mm (displaced to the optical disk side by 0.1 mm), spherical aberration of +0.02 λrms occurs.

When the temperature decreases, the collimator lens CL is displaced to the optical disk side by driving the actuator ACT2. When the temperature increases, the collimator lens CL is displaced to the light source side. Accordingly, spherical aberration caused by a temperature change can be canceled to theoretically eliminate spherical aberration in the entire optical system. Hence, information can appropriately be recorded and/or reproduced on/from the information recording surface RL of the optical disk D1. The collimator lens CL exhibits the same characteristic as described above even when the light source wavelength is 660 nm, although not illustrated. Hence, when the collimator lens is displaced in the direction of optical axis in a similar way, spherical aberration caused by a temperature change can be canceled.

The refractive index of the beam shaping lens BSL may change in accordance with a temperature change, and accordingly, astigmatism may occur. Especially, in the present invention, the shape of the beam shaping lens is adjusted to prevent astigmatism even when the refractive index changes. When the beam shaping lens is made of glass, the change in refractive index caused by a temperature change is small. Hence, spherical aberration degradation or astigmatism degradation can be neglected. Even when the beam shaping lens BSL is made of plastic, astigmatism can be corrected by displacing the beam shaping lens in the direction of optical axis by using an actuator ACT3.

On-axis chromatic aberration which occurs in accordance with a change in light source wavelength from the reference value can be corrected by displacing the collimator lens CL when a predetermined wavelength is obtained in accordance with the individual differences of the light sources. However, if the light source wavelength instantaneously varies due to mode-hop as a problem in semiconductor lasers, the on-axis chromatic aberration cannot be corrected by displacing the collimator lens CL. In the present invention, a diffraction structure is formed between the collimator lens CL and the objective lens OBL. With this arrangement, wave aberration which occurs when the light source wavelength λ1 shifts by ±1 nm with respect to the reference wavelength 407 nm is suppressed to 0.011 λrms. In addition, wave aberration which occurs when the light source wavelength λ2 shifts by ±1 nm with respect to the reference wavelength 660 nm is suppressed to 0.010 λrms. These levels pose no problem in practical use.

As for the detailed arrangement of the actuators ACT1 and ACT2, various conventionally known mechanisms can be employed, and a detailed description thereof will be omitted. As an example, as disclosed in Japanese Unexamined Patent Publication No. 2002-373441, the collimator lens may be driven to a desired position on the basis of a discrimination signal obtained by discriminating the type of the optical disk.

Lens data shown in Tables 1-1, 1-2, and 2 are examples suitably used for the optical system according to the first embodiment shown in FIG. 1. Lens data shown in Table 1-1 are related to the optical system for a light beam (e.g., a blue-violet semiconductor laser beam) emitted from the first semiconductor laser LD1. Lens data shown in Table 1-2 are related to the optical system for a light beam (e.g., a red semiconductor laser beam) emitted from the second semiconductor laser LD2.

In the optical pickup apparatus according to the first embodiment, the aspect ratio of the light beam which enters the beam shaping lens is 2.7. The beam shaping magnification is 2.55. An image-side numerical aperture NA is 0.65.

Referring to Table 2, a power of 10 (e.g., ×10⁻¹) is expressed by using E (e.g., E-3).

TABLE 1-1

| Surface | Optical | Radius of Curvature | | d | n |
|---|---|---|---|---|---|
| Number | Element | Y-Axis | X-Axis | (407 nm) | (407 nm) |
| 1 | light source | | | 0.251 | |
| 2 | cover glass | | | 0.250 | 1.5299 |
| 3 | | | | 1.185 | |
| 4 | Beam shaping | −0.2420 | −15.0970 | 2.000 | 1.5246 |
| | lens | | | | |
| 5 | | −1.9885 | −28.1627 | 2.000 | |
| 6 | cover glass | | | 8.000 | 1.5299 |
| 7 | | | | 2.118 | |
| 8 | Coupling lens | 48.8086 | 48.8086 | 2.000 | 1.5246 |
| 9 | | −10.4092 | −10.4092 | 0.000 | |
| 10 | | | | 5.000 | |
| 11 | stop | | | 0.100 | |
| 12 | objective lens | 1.8537 | 1.8537 | 1.730 | 1.5428 |
| 13 | | −8.9967 | −8.9967 | 0.000 | |
| 14 | | | | 1.644 | |
| 15 | disk | | | 0.600 | 1.6187 |
| 16 | | | | 0.000 | |

TABLE 1-2

| | Optical | | |
|---|---|---|---|
| Surface Number | Element | d (655 nm) | n (655 nm) |
| 3 | light source | 0.251 | |
| 4 | cover glass | 0.250 | 1.5142 |
| 5 | | 4.680 | |
| 6 | cover glass | 8.000 | 1.5142 |
| 7 | | 2.118 | |
| 8 | coupling lens | 2.000 | |
| 9 | | 0.000 | |
| 10 | | 4.943 | |
| 11 | stop | 0.100 | |
| 12 | objective lens | 1.730 | 1.5290 |
| 13 | | 0.000 | |
| 14 | | 1.701 | |
| 15 | disk | 0.600 | 1.5772 |
| 16 | | 0.000 | |

TABLE 2
Coefficient of Non-Arc Surface, Aspherical Surface, and
Optical Path Difference Function
4th Surface: Arc Toroidal Surface (Y direction)

κx = −2.3135E−0
Ax₄ = +6.4855E−3

5th Surface: Non-Arc Toroidal Surface (Y direction)

κx = −6.2651E−1
Ax₄ = +5.3486E−2

9th Surface: Aspherical Surface Coefficient

κ = −1.0000E−1
A₄ = +6.2268E−5
A₆ = +6.6403E−7

Optical Path Difference Function (Optical Path Difference
Function Coefficient: Reference Wavelength 407 nm 3rd
Order Diffraction)

C2: +7.0000E−3

12th Surface: Aspherical Surface Coefficient

κ = −6.3473E−1
A₄ = +7.1931E−4
A₆ = +6.3828E−4
A₈ = −1.4052E−4
A₁₀ = +2.5198E−6
A₁₂ = −1.2519E−6
A₁₄ = +1.7109E−7

Optical Path Difference Function (Optical Path Difference
Function Coefficient: Reference Wavelength 407 nm
3rd-Order Diffraction, Reference Wavelength 407 nm
3rd-Order Diffraction, Reference Wavelength 660 nm
2nd-Order Diffraction)

C₄ = −3.2561E−4
C₆ = +7.6743E−5
C₈ = −2.9314−5
C₁₀ = +2.1585E−6

13th Surface: Aspherical Surface Coefficient

κ = −5.0000E+2
A₄ = +6.7603E−3
A₆ = −1.2723E−3
A₈ = −1.0006E−4
A₁₀ = +1.1623E−4
A₁₂ = −2.5000E−5
A₁₄ = +1.9027E−6

Let the X-axis be the direction of optical axis, h be the height in the direction perpendicular to the optical axis, and r be the radius of curvature of the optical surface. In this case, an aspherical surface of the optical system can be given by

$${( z - {r}_{x} )}^{2} + {x}^{2} = [ {r}_{x} - \frac{{y}^{2}}{{r}_{y} \{ 1 + \sqrt{1 - ( 1 + {κ}_{y} ) \frac{{y}^{2}}{{r}_{y}^{2}}} \}} + \sum ( {A}_{yi} {y}^{i} ) ] \qquad ( 1 )$$

where κ be the cone constant, and A₂ᵢ is the aspherical coefficient.

For the objective lens OBL, a diffraction structure is formed on the optical surface, and the aspherical surface is represented by the optical path difference added to the transmission wavefront by the diffraction structure. Letting h be the height in a direction perpendicular to the optical axis, m be the diffraction order, λ be the operating wavelength (the emission wavelength of the semiconductor laser), λ_{B} be the brazed wavelength, and C be the optical path difference function coefficient, the optical path difference is represented by an optical path difference function Φ_{b} (mm) given by

$${Φ}_{b} = m \times \frac{λ}{{λ}_{B}} \times {\sum }_{i = 1}^{5} {C}_{2 i} {h}^{2 i} \qquad ( 2 )$$

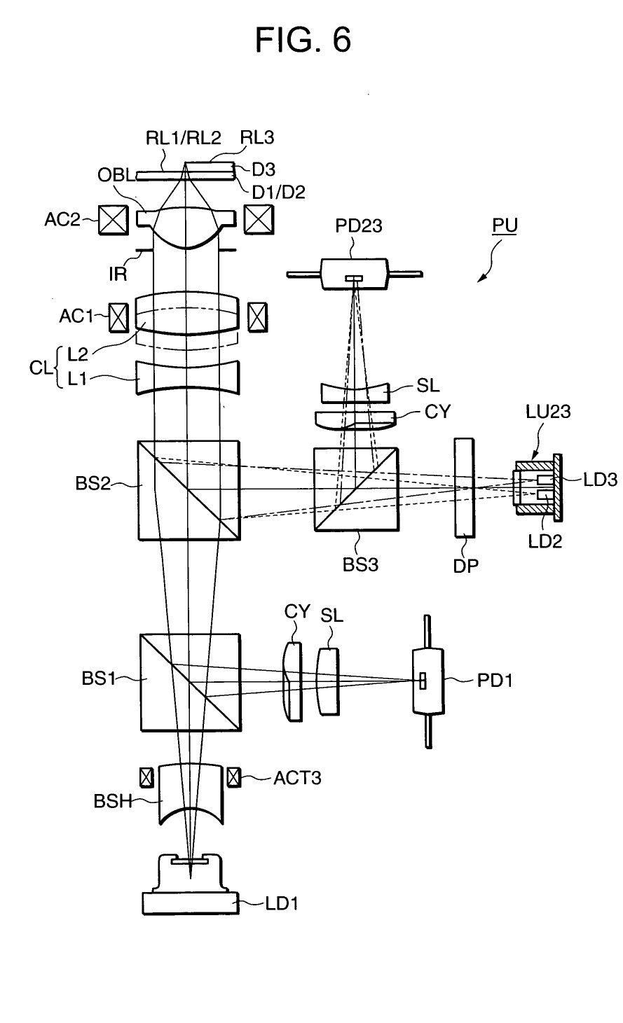

FIG. 6 is a view schematically showing the overall arrangement of an optical pickup apparatus according to the second embodiment of the present invention. In FIG. 6, the same reference numerals and symbols as in FIG. 1 denote constituent elements having the same functions and effects as in FIG. 1.

In the second embodiment shown in FIG. 6, in addition to first and second semiconductor lasers LD1 and LD2, an infrared semiconductor laser LD3 (wavelength λ3=790 nm) which is mainly used to record/reproduce information on/from a commercially available CD (third optical disk D3) is incorporated as a third light source.

In the example shown in FIG. 6, the second light source LD2 and third light source LD3 are integrated by a light source unit LU23. Hence, in the second embodiment, two beam splitters, i.e., a beam splitter BS1 used for a light beam emitted from the first light source and a beam splitter BS2 used for a light beam emitted from the second or third light source are arranged.

In a coupling lens serving as a divergence angle conversion element for an emitted light beam, two lenses, i.e., a first lens L1 having a negative refracting power and a second lens L2 having a positive refracting power are arranged sequentially from the light source side. When the optical pickup apparatus is used, the position of the second lens L2 is switched between a case in which the light beam from the first or second light source passes through the second lens L2 and a case in which the light beam from the third light source passes through the second lens L2. Accordingly, the interval between the first lens and the second lens in the direction of optical axis is changed, thereby changing the exit angle of each light beam.

An optical element indicated by a symbol DP and arranged nearby the light source unit LU23 is a diffraction plate. The diffraction plate is necessary for detecting the tracking error signal of a CD by a 3-beam method. More specifically, three diffraction light components are generated by the diffraction plate DP. The spots are condensed on the main sensor and sub sensor (neither are shown) of a photodetector PD23, and their intensity distribution is used as a tracking error signal.

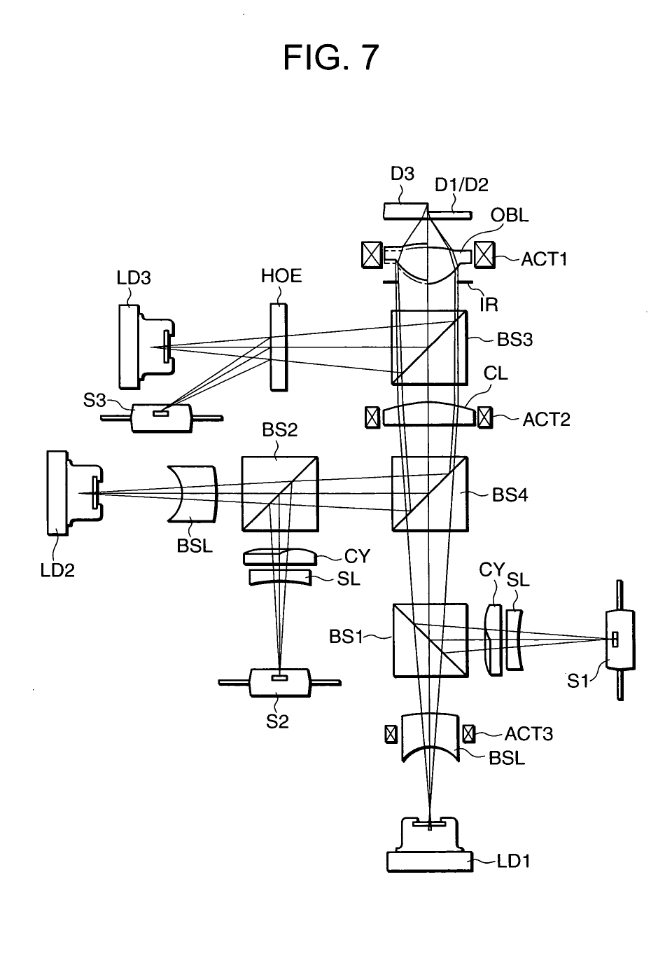

FIG. 7 is a view schematically showing the overall arrangement of an optical pickup apparatus according to the third embodiment of the present invention. In FIG. 7, the same reference numerals and symbols as in FIG. 1 denote constituent elements having the same functions and effects as in FIG. 1.

In the third embodiment shown in FIG. 7, three light sources, i.e., first to third light sources LD1, LD2, and LD3 are arranged independently. Hence, beam splitters are arranged respectively in the optical paths through which light beams emitted from the light sources pass. HOE in FIG. 7 indicates a hologram element such as a prism having a polarizing function.

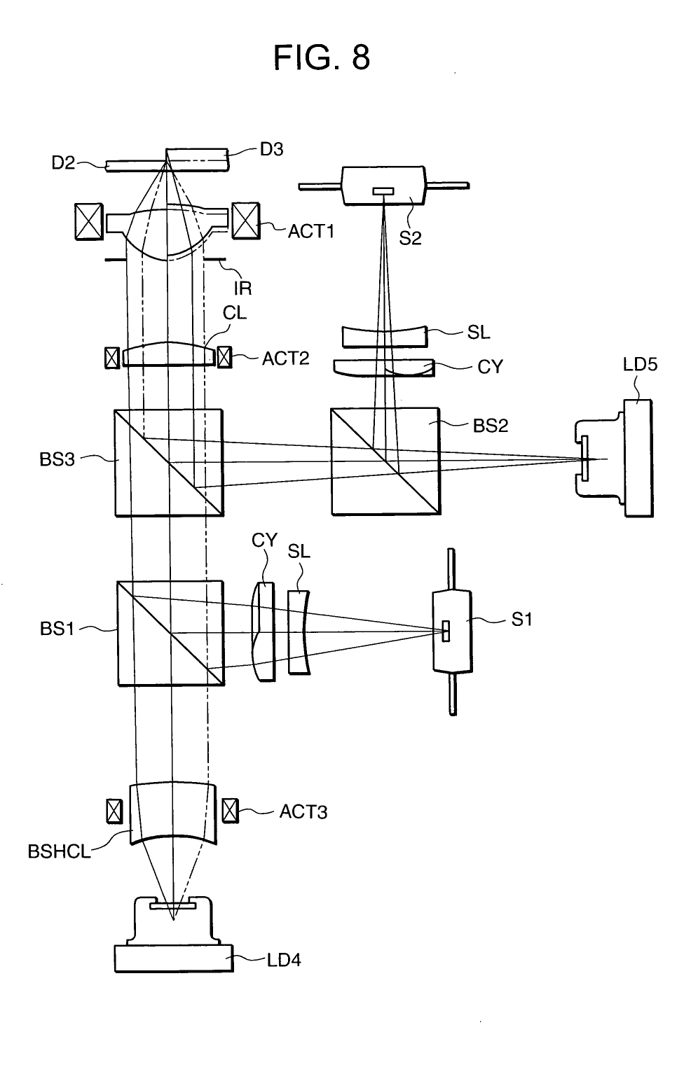

FIG. 8 is a view schematically showing the overall arrangement of an optical pickup apparatus according to the fourth embodiment of the present invention. In FIG. 8, the same reference numerals and symbols as in FIG. 1 denote constituent elements having the same functions and effects as in FIG. 1.

The fourth embodiment shown in FIG. 8 is an optical pickup apparatus which records/reproduces information on/from both a DVD (second optical disk D2) and a CD (third optical disk D3). A semiconductor laser LD4 (wavelength λ1=660 nm) is used as the light source for a DVD. A semiconductor laser LD5 (wavelength λ1=790 nm) is used as the light source for a CD.

The fourth embodiment shown in FIG. 8 is different from the first to third embodiments in that the beam shaping lens and coupling lens are formed integrally as one unit BSHCL. With this arrangement, a more compact apparatus can be provided without degrading the function.

Lens data of the fourth embodiment are shown in Tables 3, 4-1, 4-2, and 5. Lens data shown in Table 4-1 are related to the optical system for a light beam emitted from the semiconductor laser LD4. Lens data shown in Table 4-2 are related to the optical system for a light beam emitted from the semiconductor laser LD5. Referring to Table 5, a power of 10 (e.g., ×10⁻³) is expressed by using E (e.g., E-3).

TABLE 3

| | |
|---|---|
| 660 nm | 790 nm |

| | X | Y | X | Y |
|---|---|---|---|---|
| Object-Side | 0.119 | 0.060 | 0.077 | 0.077 |
| NA | | | | |
| Image-Side | 0.671 | 0.671 | 0.510 | 0.510 |
| NA | | | | |

| | | |
|---|---|---|
| Wave | 0.000 λ | 0.000 λ |
| Aberration | | |

TABLE 4-1

| i^{th} | | | | | |
|---|---|---|---|---|---|
| Sur- | | | | di | ni |
| face | | ryi | rxi | (660 nm) | (660 nm) |
| 0 | light source | | | 0.7500 | |
| 1 | cover glass | ∞ | ∞ | 0.2500 | 1.51421 |
| 2 | | ∞ | ∞ | 2.0000 | 1.00000 |
| 3 | beam | −0.5573 | ∞ | 2.4000 | 1.54076 |
| | shaping lens | | | | |
| 4 | | −2.2638 | −17.3190 | 9.1401 | 1.00000 |
| 5 | cover glass | ∞ | ∞ | 3.9500 | 1.51421 |
| 6 | | ∞ | ∞ | 0.1000 | 1.00000 |
| 7 | coupling lens | 58.2707 | 58.2707 | 1.7000 | 1.50657 |
| 8 | | −10.7108 | −10.7108 | 5.0000 | 1.00000 |
| 9 | objective | 1.7221 | 1.7221 | 1.7500 | 1.53896 |
| | lens | | | | |
| 9′ | | 1.7012 | 1.7012 | | |
| 10 | | −7.3590 | −7.3590 | 1.3788 | 1.00000 |
| 11 | disk | ∞ | ∞ | 0.6000 | 1.57718 |
| 11 | | ∞ | ∞ | 0.0000 | 1.00000 |
| 11 | | ∞ | ∞ | 0.0000 | 1.00000 |

TABLE 4-2

| i^{th} Surface | | di (790 nm) | ni (790 nm) |
|---|---|---|---|
| 0 | | | |
| 1 | | | |
| 2 | light source | 0.7500 | |
| 3 | cover glass | 0.2500 | 1.51098 |
| 4 | | 13.5000 | 1.00000 |
| 5 | cover glass | 3.9500 | 1.51098 |
| 6 | | 0.1000 | 1.00000 |
| 7 | coupling lens | 1.7000 | 1.00000 |
| 8 | | 5.3670 | 1.50336 |
| 9 | objective lens | 1.7500 | 1.00000 |
| 9′ | | | 1.53525 |
| 10 | | 1.0118 | 1.00000 |
| 11 | disk | 1.2000 | 1.57042 |
| 11 | | 0.0000 | 1.00000 |
| 11 | | 0.0000 | 1.00000 |

TABLE 5
3rd Surface: Non-Arc Cylindrical Surface (Y-Direction)
coefficient

κy = −2.9651E−1
Ay₄ = +9.7766E−3
Ay₆ = +4.1698E−1
Ay₈ = +1.1874E−0

4th Surface: Anamorphic Aspherical Surface Coefficient

κx = −1.8135E+0
κy = −6.4855xE+0
E₄ = −4.5682E−3
E₆ = +4.8666E−4
E₈ = −2.3770E−4
E₁₀ = +4.8666E−10
F₄ = +7.2435E−1
F₆ = −3.4152E−1
F₈ = −3.8461E−1
F₁₀ = −1.4797E−1

5th Surface: Aspherical Surface Coefficient

κ = −1.0000E−0
A₄ = −1.2108E−5
A₄ = −2.1035E−7

9th Surface: Aspherical Surface Coefficient (h > 1.414 nm)

κ = −5.4816E−1
A₀ = +5.9538E−4
A₄ = +1.0077E−2
A₆ = −1.5443E−2
A₈ = +6.4107E−3
A₁₀ = −7.1633E−4
A₁₂ = −1.0385E−4
A₁₄ = +1.7800E−5

Optical Path Difference Function (Optical Path Difference
Function Coefficient: Reference Wavelength 660 nm Order of
Diffraction: 1st (660 nm) 1st (790 nm))

C₂ = +6.2147E−3
C₄ = −1.1200E−2
C₆ = +3.4967E−3
C₈ = −4.7159E−4
C₁₀ = +1.8398E−5

9′th Surface: Aspherical Surface Coefficient (h ≦ 1.414 nm)

κ = −2.6340E+0
A₄ = +4.9432E−2
A₆ = −1.1077E−2
A₈ = +3.7457E−3
A₁₀ = −1.1410E−3
A₁₂ = +2.5557E−4
A₁₄ = −3.0372E−5

Optical Path Difference Function (Optical Path Difference
Function Coefficient: Reference Wavelength 660 nm Order of
Diffraction: 1st (660 nm) 1st (790 nm))

C₂ = 0.0000E+0
C₄ = −2.7541E−3
C₆ = −1.3706E−4
C₈ = −8.3810E−5
C₁₀ = +8.3810E−6

10th Surface: Aspherical Surface Coefficient

κ = +3.9749E+0
A₄ = +2.6293E−2
A₆ = −8.3639E−3
A₈ = +4.3279E−3
A₁₀ = −2.1536E−3
A₁₂ = +5.4371E−4
A₁₄ = −5.1461E−5

The “non-Arc cylindrical (Y-Direction) surface” indicates a modification of a non-arc toroidal (Y-Direction) surface in which “rx” becomes infinity.

The anamorphic aspherical surface of the optical system can be given by the following equation (3) in which “rx” represents the radius of curvature on the direction of the X-axis, “κy” the radius of curvature on the direction of the Y-axis, “κx” a conic coefficient on the direction of the X-axis, “κy” a conic coefficient on the direction of the Y-axis, “Ei” a rotational symmetry portion, and Fi a non rotational symmetry portion.

$$z = \frac{\frac{{x}^{2}}{{r}_{x}} + \frac{{y}^{2}}{{r}_{y}}}{1 + \sqrt{\{ 1 - ( 1 + {κ}_{x} ) \frac{{x}^{2}}{{r}_{x}^{2}} - ( 1 + {κ}_{y} ) \}} \frac{{y}^{2}}{{r}_{y}^{2}}} + \\ \sum [ {E}_{i} {\{ ( 1 - {F}_{i} ) {x}^{2} + ( 1 + {F}_{i} ) {y}^{2} \}}^{i} ] \qquad ( 3 )$$

A characteristic of the anamorphic aspherical surface is in that all of cross-sections thereof including the optical axis have non-arc.

In addition to the foregoing first to third main aspects, the optical pickup apparatus of the present invention has the following subsidiary aspects.

(1) The ratio α with respect to the first light beam emitted from the beam shaping element satisfies an inequality of 1.2≦α≦2.7, preferably 1.5≦α≦2.5.

(2) The divergence angle conversion element is arranged to be displaceable on a direction of an optical axis thereof, and makes it possible to correct spherical aberration which occurs in accordance with a change in temperature in the optical system when the position of the divergence angle conversion element is displaced on the direction of the optical axis.

(3) The divergence angle conversion element is arranged to be displaceable on a direction of an optical axis thereof, and makes it possible to correct spherical aberration which occurs in accordance with a change in wavelength of the first light source and/or the second light source when the position of the divergence angle conversion element is displaced on the direction of the optical axis.

(4) The beam shaping element is arranged to be displaceable on a direction of an optical axis thereof, and makes it possible to correct spherical aberration which occurs in accordance with a change in temperature in the optical system when the position of the beam shaping element is displaced on the direction of the optical axis.

(5) The beam shaping element is arranged to be displaceable on a direction of an optical axis thereof, and makes it possible to correct spherical aberration which occurs in accordance with a change in wavelength of the first light source when the position of the beam shaping element is displaced on the direction of the optical axis.

(6) At least each one of optical surfaces of the divergence angle conversion element and the objective lens has a diffraction structure which makes it possible to correct spherical aberration which occurs in accordance with a change in temperature in the optical system.

(7) At least each one of optical surfaces of the divergence angle conversion element and the objective lens has a diffraction structure which makes it possible to correct spherical aberration which occurs in accordance with a change in wavelength of the first light source and/or the second light source.

According to the above subsidiary aspects (2) to (7), it becomes possible to correct appropriately spherical aberration which occurs in accordance with a change in temperature in the optical system and/or a change in wavelength of the light source.

(8) The divergence angle conversion element includes two or more optical elements.

(9) At least one optical element of the divergence angle conversion element is arranged to be displaceable.

According to the above subsidiary aspects (8) to (9), in case at least one of the beam shaping element, divergence angle conversion element, and objective lens is made of plastic, spherical aberration degradation caused by a change in refractive index in accordance with a change in temperature is corrected, and further spherical aberration degradation caused by a change in light source wavelength is corrected.

(10) The beam shaping element is essentially made of glass.

According to the above subsidiary aspect (10), it becomes possible to decrease caused by a change in temperature.

(11) A beam splitter is arranged in each of optical paths through which the first light beam emitted from the first light source and the second light beam emitted from the second light source pass.

(12) In an optical pickup apparatus according to the first or the second main aspects, it further comprises a third light source having a wavelength λ3 (λ2<λ3), wherein information can be recorded and/or reproduced on/from an information recording surface of a third optical information recording medium by condensing, through the objective lens, a light beam from the third light source on the information recording surface of the third optical information recording medium covered with a protective layer having a thickness t3 (t2<t3).

According to the above subsidiary aspect (12), a compact and superior cost benefit optical pickup apparatus is produced, and further information can appropriately be recorded and/or reproduced on/from different three kinds of optical information recording media including, e.g., a high-density DVD, a DVD, and a CD.

(13) In the above subsidiary aspect (12), the second light source and the third light source are arranged in a common light source unit, and the light beams emitted from the second light source and the third light source pass through a common optical path.

According to the above subsidiary aspect (13), a compact optical pickup apparatus is produced.

(14) In the above subsidiary aspect (13), a beam splitter is arranged in each of the optical path through which the first light beam emitted from the first light source passes and the optical path through which the light beam emitted from one of the second light source and the third light source passes.

(15) In the above subsidiary aspect (12), the first light source, the second light source, and the third light source are arranged independently of one anther.

(16) In the above subsidiary aspect (15), a beam splitter is arranged in each of the optical paths through which respective light beams emitted from the first light source, the second light source, and the third light source pass, respectively.

(17) The beam shaping element has a divergence angle reducing function for reducing an angle of divergence of the first light beam.

According to the above subsidiary aspect (17), a more compact apparatus is produced while maintaining a high light utilization efficiency.

The present invention has been described above with reference to several illustrated embodiments. However, the present invention should not be interpreted in only the above-described embodiments, and various changes and modifications can appropriately be made. For example, instead of driving the collimator lens in the direction of optical axis, a diffraction structure which corrects spherical aberration caused by a temperature change may be formed in the collimator lens or objective lens. A coupling lens which receives a divergent light beam and outputs a divergent light beam with another angle or a convergent light beam may be arranged in place of the collimator lens. The light beam from the third light source (wavelength λ3=770 to 790 nm and, for example, 785 nm) may be condensed on the information recording surface of the third optical disk through the above-described optical system to record and/or reproduce information.

1. An optical pickup apparatus, comprising:
a first light source emitting a first light beam having a wavelength λ1;
a second light source emitting a second light beam having a wavelength λ2 (λ1<λ2); and
an optical system including a beam shaping element which is arranged in an optical path through which only the first light beam passes, a divergence angle conversion element which is arranged in an optical path through which the first and the second light beams pass, and an objective lens,
in which the apparatus being configured to make it possible to record and/or reproduce information by condensing, through the objective lens, the first light beam on a first optical information recording medium covered with a protective layer having a thickness t1, and make it possible to record and/or reproduce information by condensing the second light beam on a second optical information recording medium covered with a protective layer having a thickness t2 (t1≦t2),
wherein the beam shaping element is so made as to output the first light beam having a nearer circle cross-section, while the first light beam just after emitted from the first light source having an elliptical cross-section, which is defined by tracing points with an intensity 50% of a peak intensity of the first light beam and effects an inequality α>1 in which α is a ratio of a length “x” of the major axis of the elliptical cross-section to a length “y” of the minor axis thereof, and
wherein the divergence angle conversion element is so made as to output the first light beam and the second light beam whose respective divergence angles are reduced.

2. An apparatus according to claim 1, wherein the ratio α with respect to the first light beam emitted from the beam shaping element satisfies an inequality of 1.2≦α≦2.7.

3. An apparatus according to claim 1, wherein the divergence angle conversion element is arranged to be displaceable on a direction of an optical axis thereof, and makes it possible to correct spherical aberration which occurs in accordance with a change in temperature in the optical system when the position of the divergence angle conversion element is displaced on the direction of the optical axis.

4. An apparatus according to claim 1, wherein the divergence angle conversion element is arranged to be displaceable on a direction of an optical axis thereof, and makes it possible to correct spherical aberration which occurs in accordance with a change in wavelength of the first light source and/or the second light source when the position of the divergence angle conversion element is displaced on the direction of the optical axis.

5. An apparatus according to claim 1, wherein the beam shaping element is arranged to be displaceable on a direction of an optical axis thereof, and makes it possible to correct spherical aberration which occurs in accordance with a change in temperature in the optical system when the position of the beam shaping element is displaced on the direction of the optical axis.

6. An apparatus according to claim 1, wherein the beam shaping element is arranged to be displaceable on a direction of an optical axis thereof, and makes it possible to correct spherical aberration which occurs in accordance with a change in wavelength of the first light source when the position of the beam shaping element is displaced on the direction of the optical axis.

7. An apparatus according to claim 1, wherein at least each one of optical surfaces of the divergence angle conversion element and the objective lens has a diffraction structure which makes it possible to correct spherical aberration which occurs in accordance with a change in temperature in the optical system.

8. An apparatus according to claim 1, wherein at least each one of optical surfaces of the divergence angle conversion element and the objective lens has a diffraction structure which makes it possible to correct spherical aberration which occurs in accordance with a change in wavelength of the first light source and/or the second light source.

9. An apparatus according to claim 1, wherein the divergence angle conversion element includes two or more optical elements.

10. An apparatus according to claim 1, wherein at least one optical element of the divergence angle conversion element is arranged to be displaceable. the direction of optical axis by an actuator.

11. An apparatus according to claim 1, wherein the beam shaping element is essentially made of glass.

12. An apparatus according to claim 1, wherein a beam splitter is arranged in each of optical paths through which the first light beam emitted from the first light source and the second light beam emitted from the second light source pass.

13. An apparatus according to claim 1, further comprising a third light source having a wavelength λ3 (λ2<λ3), wherein information can be recorded and/or reproduced on/from an information recording surface of a third optical information recording medium by condensing, through the objective lens, a light beam from the third light source on the information recording surface of the third optical information recording medium covered with a protective layer having a thickness t3 (t2<t3).

14. An apparatus according to claim 13, wherein the second light source and the third light source are arranged in a common light source unit, and the light beams emitted from the second light source and the third light source pass through a common optical path.

15. An apparatus according to claim 14, wherein a beam splitter is arranged in each of the optical path through which the first light beam emitted from the first light source passes and the optical path through which the light beam emitted from one of the second light source and the third light source passes.

16. An apparatus according to claim 13, wherein the first light source, the second light source, and the third light source are arranged independently of one anther.

17. An apparatus according to claim 16, wherein a beam splitter is arranged in each of the optical paths through which respective light beams emitted from the first light source, the second light source, and the third light source pass, respectively.

18. An apparatus according to claim 1, wherein the beam shaping element has a divergence angle reducing function for reducing an angle of divergence of the first light beam.

19. An optical pickup apparatus, comprising:
a first light source emitting a first light beam having a wavelength λ1;
a second light source emitting a second light beam having a wavelength λ2 (λ1<λ2); and
an optical system including a beam shaping element which is arranged in an optical path through which only the first light beam passes, a divergence angle conversion element which is arranged in an optical path through which the first and the second light beams pass, and an objective lens,
in which the apparatus being configured to make it possible to record and/or reproduce information by condensing, through the objective lens, the first light beam on a first optical information recording medium covered with a protective layer having a thickness t1, and make it possible to record and/or reproduce information by condensing the second light beam on a second optical information recording medium covered with a protective layer having a thickness t2 (t1≦t2),
wherein the beam shaping element is so made as to output the first light beam having an approximately circle cross-section, while the first light beam just after emitted from the first light source having an elliptical cross-section, which is defined by tracing points with an intensity 50% of a peak intensity of the first light beam and effects an inequality a>1 in which α is a ratio of a length “x” of the major axis of the elliptical cross-section to a length “y” of the minor axis thereof, and
wherein the divergence angle conversion element is so made as to output the first light beam and the second light beam whose respective divergence angles are reduced.

20. An apparatus according to claim 19, wherein the ratio α with respect to the first light beam emitted from the beam shaping element satisfies an inequality of 1.2≦α≦2.7.

21. An apparatus according to claim 19, wherein the divergence angle conversion element is arranged to be displaceable on a direction of an optical axis thereof, and makes it possible to correct spherical aberration which occurs in accordance with a change in temperature in the optical system when the position of the divergence angle conversion element is displaced on the direction of the optical axis.

22. An apparatus according to claim 19, wherein the divergence angle conversion element is arranged to be displaceable on a direction of an optical axis thereof, and makes it possible to correct spherical aberration which occurs in accordance with a change in wavelength of the first light source and/or the second light source when the position of the divergence angle conversion element is displaced on the direction of the optical axis.

23. An apparatus according to claim 19, wherein the beam shaping element is arranged to be displaceable on a direction of an optical axis thereof, and makes it possible to correct spherical aberration which occurs in accordance with a change in temperature in the optical system when the position of the beam shaping element is displaced on the direction of the optical axis.

24. An apparatus according to claim 19, wherein the beam shaping element is arranged to be displaceable on a direction of an optical axis thereof, and makes it possible to correct spherical aberration which occurs in accordance with a change in wavelength of the first light source when the position of the beam shaping element is displaced on the direction of the optical axis.

25. An apparatus according to claim 19, wherein at least each one of optical surfaces of the divergence angle conversion element and the objective lens has a diffraction structure which makes it possible to correct spherical aberration which occurs in accordance with a change in temperature in the optical system.

26. An apparatus according to claim 19, wherein at least each one of optical surfaces of the divergence angle conversion element and the objective lens has a diffraction structure which makes it possible to correct spherical aberration which occurs in accordance with a change in wavelength of the first light source and/or the second light source.

27. An apparatus according to claim 19, wherein the divergence angle conversion element includes two or more optical elements.

28. An apparatus according to claim 19, wherein at least one optical element of the divergence angle conversion element is arranged to be displaceable. the direction of optical axis by an actuator.

29. An apparatus according to claim 19, wherein the beam shaping element is essentially made of glass.

30. An apparatus according to claim 19, wherein a beam splitter is arranged in each of optical paths through which the first light beam emitted from the first light source and the second light beam emitted from the second light source pass.

31. An apparatus according to claim 19, further comprising a third light source having a wavelength λ3 (λ2<λ3), wherein information can be recorded and/or reproduced on/from an information recording surface of a third optical information recording medium by condensing, through the objective lens, a light beam from the third light source on the information recording surface of the third optical information recording medium covered with a protective layer having a thickness t3 (t2<t3).

32. An apparatus according to claim 31, wherein the second light source and the third light source are arranged in a common light source unit, and the light beams emitted from the second light source and the third light source pass through a common optical path.

33. An apparatus according to claim 32, wherein a beam splitter is arranged in each of the optical path through which the first light beam emitted from the first light source passes and the optical path through which the light beam emitted from one of the second light source and the third light source passes.

34. An apparatus according to claim 31, wherein the first light source, the second light source, and the third light source are arranged independently of one anther.

35. An apparatus according to claim 34, wherein a beam splitter is arranged in each of the optical paths through which respective light beams emitted from the first light source, the second light source, and the third light source pass, respectively.

36. An apparatus according to claim 19, wherein the beam shaping element has a divergence angle reducing function for reducing an angle of divergence of the first light beam.

37. An optical pickup apparatus, comprising:
a first light source emitting a first light beam having a wavelength λ1;
a second light source emitting a second light beam having a wavelength λ2 (λ1<λ2);
a third light source emitting a third light beam having a wavelength λ3 (λ2<λ3); and
an optical system including a first beam shaping element which is arranged in an optical path through which only the first light beam passes, a second beam shaping element which is arranged in an optical path through which only the second light beam passes, a divergence angle conversion element which is arranged in a common optical path through which the first and the second light beams pass, and an objective lens,
in which the apparatus being configured to make it possible to record and/or reproduce information by condensing, through the objective lens, the first light beam on a first optical information recording medium covered with a protective layer having a thickness t1, and in which make it possible to record and/or reproduce information by condensing the second light beam on a second optical information recording medium covered with a protective layer having a thickness t2 (t1≦t2), and in which make it possible to record and/or reproduce information by condensing the third light beam on a third optical information recording medium covered with a protective layer having a thickness t3 (t2<t3),
wherein the beam shaping element is so made as to output the first light beam having a nearer circle cross-section, while the first light beam just after emitted from the first light source having an elliptical cross-section, which is defined by tracing points with an intensity 50% of a peak intensity of the first light beam and effects an inequality α>1 in which α is a ratio of a length “x” of the major axis of the elliptical cross-section to a length “y” of the minor axis thereof, and
wherein the divergence angle conversion element is so made as to output the first light beam and the second light beam whose respective divergence angles are reduced.

38. An apparatus according to claim 37, wherein the ratio α with respect to the first light beam emitted from the beam shaping element satisfies an inequality of 1.2≦α≦2.7.

39. An apparatus according to claim 37, wherein the divergence angle conversion element is arranged to be displaceable on a direction of an optical axis thereof, and makes it possible to correct spherical aberration which occurs in accordance with a change in temperature in the optical system when the position of the divergence angle conversion element is displaced on the direction of the optical axis.

40. An apparatus according to claim 37, wherein the divergence angle conversion element is arranged to be displaceable on a direction of an optical axis thereof, and makes it possible to correct spherical aberration which occurs in accordance with a change in wavelength of the first light source and/or the second light source when the position of the divergence angle conversion element is displaced on the direction of the optical axis.

41. An apparatus according to claim 37, wherein the beam shaping element is arranged to be displaceable on a direction of an optical axis thereof, and makes it possible to correct spherical aberration which occurs in accordance with a change in temperature in the optical system when the position of the beam shaping element is displaced on the direction of the optical axis.

42. An apparatus according to claim 37, wherein the beam shaping element is arranged to be displaceable on a direction of an optical axis thereof, and makes it possible to correct spherical aberration which occurs in accordance with a change in wavelength of the first light source when the position of the beam shaping element is displaced on the direction of the optical axis.

43. An apparatus according to claim 37, wherein at least each one of optical surfaces of the divergence angle conversion element and the objective lens has a diffraction structure which makes it possible to correct spherical aberration which occurs in accordance with a change in temperature in the optical system.

44. An apparatus according to claim 37, wherein at least each one of optical surfaces of the divergence angle conversion element and the objective lens has a diffraction structure which makes it possible to correct spherical aberration which occurs in accordance with a change in wavelength of the first light source and/or the second light source.

45. An apparatus according to claim 37, wherein the divergence angle conversion element includes two or more optical elements.

46. An apparatus according to claim 45, wherein at least one optical element of the divergence angle conversion element is arranged to be displaceable.

47. An apparatus according to claim 37, wherein each one of optical elements forming the first and the second beam shaping elements is essentially made of glass.

48. An apparatus according to claim 47, wherein a beam splitter is arranged in each of optical paths through which the first light beam emitted from the first light source and the second light beam emitted from the second light source pass.

49. An apparatus according to claim 37, wherein the first light source, the second light source, and the third light source are arranged independently of one anther.
